(19) United States
(12) Patent Application Publication
(10) Pub. No.: US 2025/0381872 A1
(43) Pub. Date: Dec. 18, 2025

(54) DYNAMIC OPTIMIZATION FOR VEHICLE ENERGY SYSTEM CHARGING

(71) Applicant: GM Global Technology Operations LLC, Detroit, MI (US)

(72) Inventors: Shobhit Gupta, Sterling Heights, MI (US); Jun-mo Kang, Ann Arbor, MI (US); Yongjie Zhu, Troy, MI (US); Wesley Gerard Zanardelli, Rochester, MI (US); Xueyu Zhang, Northville, MI (US); Chunhao J. Lee, Troy, MI (US)

(21) Appl. No.: 18/746,925

(22) Filed: Jun. 18, 2024

(51) Int. Cl. B60L 53/62

(52) U.S. Cl. CPC B60L 53/62; B60L 2250/16

(57) ABSTRACT

A vehicle includes an electric powered propulsion system. An electric energy storage system is electrically connected to the electric propulsion system and is configured to have an electrical energy storage component and a controller. A charging port is connected to the electric energy storage system and configured to connect to an external power source. The controller includes a memory and a processor. The memory stores instructions for causing the processor to optimize a charging profile based on a plurality of received parameters using a multi-objective constrained optimization problem. The received parameters include a power type of a connected external power source, and at least one of a requested ready to depart time, a targeted state of charge, and an effective range.

### INTRODUCTION

The subject disclosure relates to vehicles, and in particular to optimized charging systems for energy storage systems within a vehicle.

Electric and hybrid electric vehicles include onboard energy storage components (e.g., batteries) which can be charged via connections to an external charger. In order to ensure that the vehicle is able to be utilized when necessary, some vehicles default to a maximized charging rate based on the available power output from the external charger.

In addition to available power from the external charger, the charging rate of the onboard energy storage systems is dependent on the ambient temperature of the energy storage components, with a higher ambient temperature resulting in a faster charging rate. The particular relationship between the charging rate of the energy storage system is a function of the available power and the ambient temperature, with the function being knowable for any given system according to conventional techniques.

In some instances the vehicle may not be needed until well after the fastest charging time (e.g., when the vehicle is not need until the next day). In these cases, defaulting to the parameters for a fastest possible charge rate may result in unnecessary expenditure of energy, and a less efficient charge. Accordingly, it is desirable to provide a dynamic optimization system for the charge rate capable of altering the charge rate parameters based on one or more user inputs.

### SUMMARY

In one exemplary embodiment a vehicle includes an electric powered propulsion system. An electric energy storage system is electrically connected to the electric propulsion system and is configured to have an electrical energy storage component and a controller. A charging port is connected to the electric energy storage system and configured to connect to an external power source. The controller includes a memory and a processor. The memory stores instructions for causing the processor to optimize a charging profile based on a plurality of received parameters using a multi-objective constrained optimization problem. The received parameters include a power type of a connected external power source, and at least one of a requested ready to depart time, a targeted state of charge, and an effective range.

In addition to one or more of the features described herein the received parameters include one of a requested ready to depart time and an effective and wherein the targeted state of charge is derived from the received parameters using the controller.

In addition to one or more of the features described herein further includes a display connected to the controller, wherein the controller is configured to cause the display to illustrate a real time charging profile.

In addition to one or more of the features described herein the display includes at least one of an integrated screen and a mobile device.

In addition to one or more of the features described herein the display includes an input and wherein the controller is configured to receive an update to at least one of the received parameters, the controller being further configured to determine a magnitude of the update.

In addition to one or more of the features described herein the controller is further configured to respond to the magnitude exceeding a predefined magnitude threshold by re-optimizing the charging profile based on the plurality of received parameters using the multi-objective constrained optimization problem, wherein the plurality of received parameters includes the update to the at least one of the received parameters.

In addition to one or more of the features described herein the predefined magnitude threshold is a static magnitude.

In addition to one or more of the features described herein the plurality of received parameters includes a selected charging type.

In addition to one or more of the features described herein a connected external power source is a level two power source and wherein the selected charging type is one of an eco charging and a normal charging.

In addition to one or more of the features described herein a connected external power source is a level three power source and wherein the selected charging type is one of an eco charging, a normal charging, and an aggressive charging.

In another exemplary embodiment a process for determining a charging profile of a vehicle includes receiving a plurality of received parameters at a controller, determining a charging profile based on the received parameters according to a multi-objective constrained optimization problem using the controller, and wherein the received parameters include a power type of a connected external power source, and at least one of a requested ready to depart time, a targeted state of charge, and an effective range.

In addition to one or more of the features described herein the received parameters include one of a requested ready to depart time and an effective and wherein the targeted state of charge is derived from the received parameters using the controller.

In addition to one or more of the features described herein includes displaying a real time charging profile via at least one display connected to the controller.

In addition to one or more of the features described herein the at least one display includes at least one of an integrated screen and a mobile device.

In addition to one or more of the features described herein includes receiving an update to at least one of the received parameters via an input associated with the at least one of the integrated screen and the mobile device, and determining a magnitude of the update.

In addition to one or more of the features described herein includes responding to the magnitude exceeding a predefined magnitude threshold by re-optimizing the charging profile based on the plurality of received parameters using the multi-objective constrained optimization problem, wherein the plurality of received parameters includes the update to the at least one of the received parameters.

In addition to one or more of the features described herein the predefined magnitude threshold is a static magnitude.

In addition to one or more of the features described wherein the predefined magnitude threshold is a percentage change in magnitude.

In addition to one or more of the features described herein the plurality of received parameters includes a selected charging type.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic view of a vehicle;

FIG. 2 is a diagrammatic representation of a vehicle energy charging system; and

FIG. 3 is a set of charts illustrating variable charging curves available using the energy charging system of claim 2.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to any of a single dedicated controller including a processor and a memory, a processing module operating on a general controller for a system, a network of controllers configured to work cooperatively to implement a control process or system, or any similar control configuration.

In accordance with an exemplary embodiment, a controller for a vehicle energy system includes a charging optimization control module. The charging optimization control module is configured to receive a set of inputs, and energy storage parameters from a user. Based on the received inputs and energy storage parameters, as well as one or more additional optional state inputs, the optimization control module solves a multi-objective constrained optimization problem to determine a suitable charging profile. The suitable charging profile is then implemented and the vehicle is charged.

In some instances, the control module can be configured to update and/or resolve the multi-objective constrained optimization problem in response to one or more of the parameters or states changing by at least a predetermined amount.

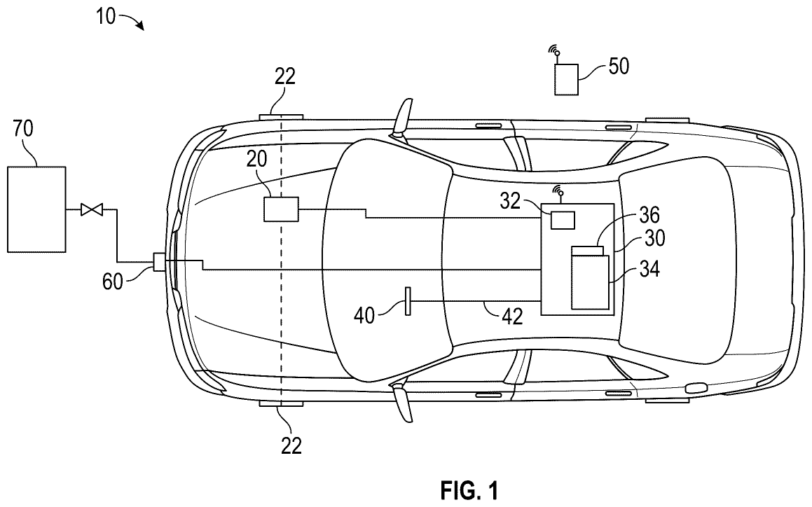

FIG. 1 illustrates a vehicle 10 including an electric powered propulsion system 20. The propulsion system 20 is connected to, and drives rotation of front wheels 22, and receives electrical power from an energy storage system 30. The energy storage system 30 includes an energy storage system controller (controller 32) and an onboard energy storage component (battery 34). In alternate examples, alternate energy storage components, arrangements of multiple energy storage components working cooperatively, and/or any similar configuration for storing electrical energy can be utilized to similar effect.

The energy storage system 30 is connected to a user input 40, such as an infotainment screen, via a wired connection 42, and to a remote device 50 such as a cell phone or other computer operating a corresponding computer application (app).

The energy storage system 30 is connected to a charging port 60, and the charging port 60 can be connected to an external power source 70. While connected to the external power source 70, the controller 32 facilitates charging the battery 34 using a dynamic charging optimization control process stored in a memory of the controller 32.

The charging time of the battery 32 is dependent on the temperature of the battery 32, such that a higher temperature of the battery 32 results in a faster charge time. In order to take advantage of this relationship, the energy storage system 30 further includes a heater 36. The heater 36 uses a portion of the electrical power received through the charging port 60 to heat the battery 30. However, any energy used to heat the battery cannot be provided to the battery for storage resulting in an optimization trade off.

Conventional vehicles, and similar systems, resolve this tradeoff using known optimization algorithms which determine the fastest possible charging rate in order to make the vehicle 10 ready for travel as soon as possible.

With the inclusion of the screen 40 and/or the connected remote device 50, additional information can be provided to the controller 32 including an expected next time the vehicle 10 will be needed and a targeted state of charge percent. In some examples, the targeted state of charge percent may be derived by the controller from additional information including a distance of the next trip, an expected time of day of the next trip, etc. This additional information is used by the controller 30 to generate an optimized charging profile using an optimized charging module.

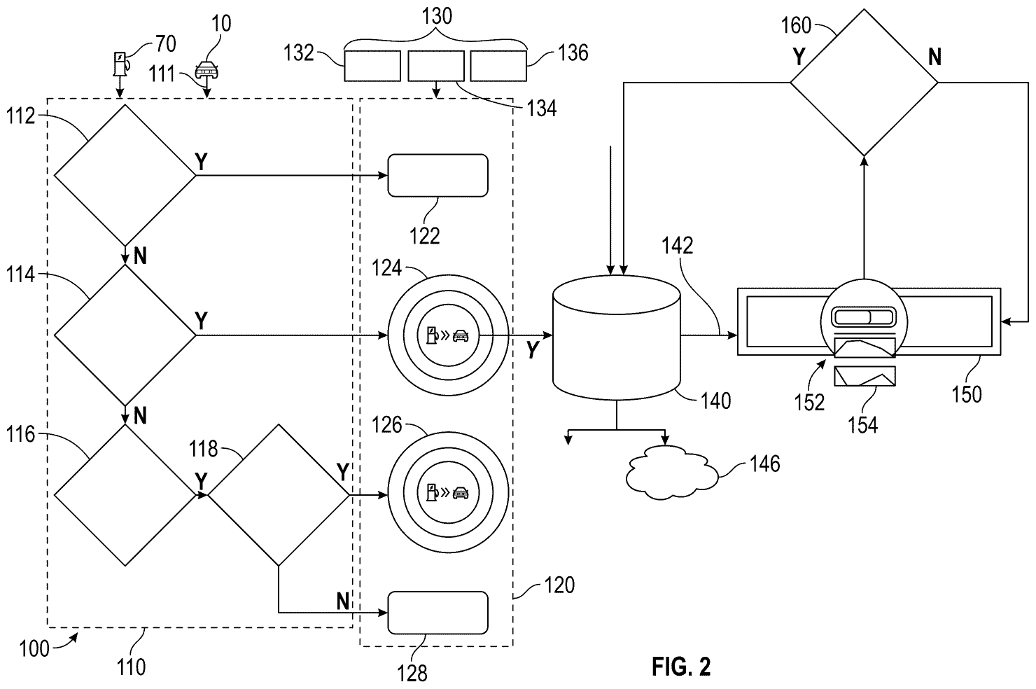

With continued reference to FIG. 1, and with like numerals indicating like elements, FIG. 2 schematically illustrates one exemplary optimized charging module 100. When initially connected to the charging station 70, the controller 32 determines what level of power is available from the external energy source 70 in a charge type determination process 110, and provides a charge type as a parameter to a set of parameters (parameters 120). In the case of smart communications, this can be communicated directly to the controller 32. In other examples, energy characteristics received from the external energy source 70 may be analyzed to determine the available power levels.

In the example determination process 110, the controller 32 receives power from the external power source 70 and a power limit value 111 of the vehicle 10 and initially determines if the external power source 70 is between 2 and 10 kW (referred to herein as “level 1”) at a level 1 power source check 112. If the external power source is a level 1 power source, the process 110 outputs a normal charging profile parameter 122.

If the external power source is not a level 1 power source, the process 110 determines if the external power source 70 is between 10 and 20 kW (referred to herein as “level 2”) in a level 2 power source check 114. If the external power source 70 is a level 2 power source, the process 110 provides a power mode selection 124 to the user, and the user is able to select whether they wish to charge in an “eco mode” parameter or a “normal” charging parameter.

As used herein, “aggressive” refers to a charging parameter optimized primarily for speed of charging, “normal” refers to a charging parameter favoring an even balance of speed and efficiency, and “eco mode” refers to a charging parameter favoring efficiency over charging speed. The specific weights for the offsetting efficiency and speed of charging for each category are system specific and can be determined by one of skill in the art.

If the level power source check 114 indicates that the external power source 70 is not a level 2 power source, the process 110 proceeds to determine whether the power from the external power source 70 exceeds 50 kW (referred to herein as “level 3”) in a level 3 power source check 116. When the external power source 70 is a level 3 power source, the process 110 then proceeds to check if the external power source includes smart charging controls in a smart charging available check 118. When the external power source 70 includes smart charging controls, the user is provided a different power mode selection 126, and the user is able to select whether they wish to charge in a first charging parameter, a second charging parameter or a third charging parameter. In one example, the first charging parameter is a “normal” mode, the second charging parameter is an “eco mode” and the third charging parameter is an “aggressive” charging parameter.

When the external power source 70 is a level 3 charger without smart charging capability (i.e., no smart charging is available) the process 110 outputs the third charging parameter 128 (the “aggressive” charging parameter in the example).

In addition to the charging characteristics of the external power source 70, the parameters 120 include a set of driver selected parameters 130. The driver selected parameters 130 include a requested ready to depart time 132 (e.g., a next trip departure time), a targeted state of charge 134, and/or an effective range 136 of the vehicle 10. The driver selected parameters 130 can be entered via one, or both, of the screen 40 and the remote device 50. Each of the driver selected parameters 130 can be used either directly (when a driver selects a targeted state of charge and/or a targeted departure time) to set the optimization parameters, or can be used to derive (e.g., when the driver selects a targeted range) the optimization parameters.

Once determined, all of the parameters 120 are provided to an optimization problem solver (solver 140) within the controller 32. The solver 140 is formulated as a non-linear constrained dynamic optimization problem, which uses a defined set of states and a control action to determine an optimal solution using a nonlinear optimization process such as dynamic programming.

In one example embodiment, the states are defined as xₜ=[qₜ, T_{bat,t}], where X is the current state of the battery at time t, q is the state of charge of the battery at time t, and T is the temperature of the battery at time t. This state is accompanied by a control action uₜ=[P_{chrg,t}, P_{heat,t}], where u is the control action, P_{chrg} is the charging power at time t, and Pₕₑₐₜ is the heating power at time t. With the described initial state and the control action, the optimal charge problem is solved using the non-linear constrained dynamic optimization problem:

$${min}_{{u}_{t}} {c}_{T ( {x}_{T} )} + {\sum }_{t = 1}^{T - 1} {c}_{T} ( {x}_{t} , {u}_{t} )$$

$$subject to : \\ 0 \leq {q}_{t} ( {P}_{chrg , t} ) \leq 1 \\ {T}^{min} \leq {T}_{bat , t} ( {P}_{heat , t} ) \leq {T}^{max}$$

$$0 \leq {P}_{chrg , t} \leq {P}_{wall}^{max} \\ \vert {P}_{heat , t} \vert \leq {P}_{heat}^{max} \\ 0 \leq {P}_{chrg , t} + \vert {P}_{heat , t} \vert \leq {P}_{wall}^{max} \\ Where ,$$

$${i}_{c , t} ( {P}_{chrg , t} , {q}_{t} ) \leq {i}_{c}^{max} ( {q}_{t} , {T}_{bat , t} )$$

In the optimal control problem (OCP), cₜ(xₜ, uₜ) refers to the stage cost, minimized at each time stage and is given as the trade-off between the time taken to charge the battery and the energy required to heat the battery pack:

$${c}_{t} ( {x}_{t} , {u}_{t} ) = γ ( 1 - {q}_{t} ( {P}_{chrg , t} ) ) + ( 1 - γ ) \vert {P}_{heat , t} \vert$$

The trade-off is represented by γ which is a tunable parameter ranging between 0 and 1. The OCP is constrained by state and control input constraints such that they do not exceed the minimum and maximum state and control input limits respectively. For instance, the state of charge is restricted between 0 and 1, the battery temperature is limited between minimum (T^{min}) and maximum battery temperature (T^{max}). The charging and heating power must be individually and jointly less than the total available wall power (P_{wall}). The charging current i_{c} is limited by the maximum allowed safe current

$${i}_{c}^{max}$$

which limits the lithium plating while charging and reduces battery degradation. As the current flows through the battery, it generates heat Pᵢₕₑₐₜ which is a function of the open circuit voltage V_{OC}. In addition to the driver entered parameters, and the detected parameters, in some implementations, the optimization problem accounts for a health of the energy system 30, a health of the battery 34, an age of the battery 34, and any similar parameters that can be known.

In some examples the optimization problem is solved via the onboard controller 32, or a network of onboard controllers, in other examples, the optimization problem solver 140 is provided to a cloud computing 146 source, or other remote data processing, and solved remotely. Once solved, the solution is provided back to the controller 32.

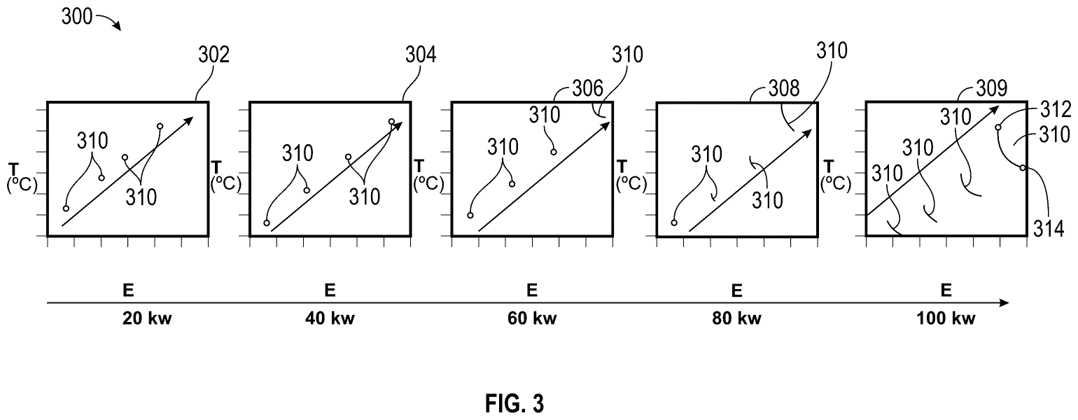

With continued reference to FIGS. 1 and 2, FIG. 3 illustrates a set 300 of exemplary charts 302, 304, 306, 308, 309 showing charging rate as a function of temperature (T) with respect to Energy (E) for a corresponding magnitude of power from an external power source. Chart 302 illustrates an external source 70 providing 20 kW, chart 304 illustrates an external source providing 40 kW, chart 306 illustrates an external source 70 providing 60 kW, chart 308 illustrates an external source 70 providing 80 kW, and chart 309 illustrates an external source 70 providing 100 kW. Each chart 302, 304, 306, 308, 309 includes state of charge plots 310 representing the temperature with respect to energy required to achieve arbitrary targeted state of charge percentages. At lower power levels (e.g., charts 302, 304, 306) the state of charge plots 310 appear as points due to the relatively low impact that temperature has on the charging efficiency at low power.

Due to scale, the particulars are best exemplified on the 100 kW chart (chart 309), illustrating that at a higher temperature (point 312), the least amount of energy is required to charge, while at a fastest charge (point 314) the most amount of energy is required to charge. The optimization problem performed by the solver 140 identifies what position on the charge plot 310 corresponding to the targeted state of charge percentage achieves the best efficiency for the parameters determined.

Referring again to FIGS. 1 and 2, the determined optimal power split 142 between heating and charging is provided to the controller 32, which controls the charging profile through the charger 60, as well as the operation of the heater 36. During the charging operation, a customer facing interface 150 is displayed to the user on either the screen 40, the remote device 50, or both. The interface 150 displays the charging profile 152 and the state of charge 154 of the battery 34 in real time.

In addition, the user is able to alter or update parameters using the interface 150. By way of example, if a user's planned next trip is delayed by three hours, the user can enter the update into the interface 150. The controller 32 uses an update check 160 and determines if the update substantially alters the parameters. When the parameters are substantially updated (e.g. the changed parameter is sufficient in size or scope of change that the optimized power split 142 may change, the check 160 returns yes, and the updated parameter is provided to the optimization problem solver 140 as a new constraint. When this occurs, the optimization problem 140 is reiterated, a new optimization split 142 is determined, and the new split is output and enforced by the controller 32.

When the changed parameter is not sufficient to warrant an updated optimization problem, the check 160 returns no, the changed parameter is logged, and no update is performed.

In some examples, a parameter may be considered sufficiently changed when the value of the parameter is altered by more than or equal to a threshold percentage. In one such example, when an expected departure time is updated by greater than 10% of the total time of the determined charge profile, an update is warranted. Similarly, if the targeted state of charge is updated by more than 10%, an update is warranted.

In addition to manually entered parameter changes, certain parameters (e.g. ambient temperature of the atmosphere) may be updated as the charge cycle progresses due to uncontrolled changes. These conditions can be monitored via sensors on the vehicle, received via connections to outside data sources (e.g., through the remote device 50), or through any other conventional means of updating the controller 32.

Implementing the optimized charging module 100 allows for a driver centered charging framework that optimizes charging based on the demands of the user including, charging times, costs, battery health, and other factors. Thermal conditioning optimization is determined using the non-linear constrained dynamic optimization algorithm combined with a single particle battery model.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric powered propulsion system;
an electric energy storage system, wherein the electric energy storage system is electrically connected to the electric powered propulsion system and configured having an electrical energy storage component and a controller;
a charging port connected to the electric energy storage system and configured to connect to an external power source; and
the controller including a memory and a processor, the memory storing instructions for causing the processor to optimize a charging profile based on a plurality of received parameters using a multi-objective constrained optimization problem, wherein the received parameters include a power type of a connected external power source, and at least one of a requested ready to depart time, a targeted state of charge, and an effective range.

2. The vehicle of claim 1, wherein the received parameters include one of a requested ready to depart time and an effective and wherein the targeted state of charge is derived from the received parameters using the controller.

3. The vehicle of claim 1, further comprising a display connected to the controller, wherein the controller is configured to cause the display to illustrate a real time charging profile.

4. The vehicle of claim 3, wherein the display includes at least one of an integrated screen and a mobile device.

5. The vehicle of claim 3, wherein the display includes an input and wherein the controller is configured to receive an update to at least one of the received parameters, the controller being further configured to determine a magnitude of the update.

6. The vehicle of claim 5, wherein the controller is further configured to respond to the magnitude exceeding a predefined magnitude threshold by re-optimizing the charging profile based on the plurality of received parameters using the multi-objective constrained optimization problem, wherein the plurality of received parameters includes the update to the at least one of the received parameters.

7. The vehicle of claim 6, wherein the predefined magnitude threshold is a static magnitude.

8. The vehicle of claim 6, wherein the predefined magnitude threshold is a percentage change in magnitude.

9. The vehicle of claim 1, wherein the plurality of received parameters includes a selected charging type.

10. The vehicle of claim 9, wherein a connected external power source is a level two power source and wherein the selected charging type is one of an eco charging and a normal charging.

11. The vehicle of claim 9, wherein a connected external power source is a level three power source and wherein the selected charging type is one of an eco charging, a normal charging, and an aggressive charging.

12. A process for determining a charging profile of a vehicle comprising:
receiving a plurality of received parameters at a controller;
determining a charging profile based on the received parameters according to a multi-objective constrained optimization problem using the controller; and
wherein the received parameters include a power type of a connected external power source, and at least one of a requested ready to depart time, a targeted state of charge, and an effective range.

13. The process of claim 12, wherein the received parameters include one of a requested ready to depart time and an effective and wherein the targeted state of charge is derived from the received parameters using the controller.

14. The process of claim 12, further comprising displaying a real time charging profile via at least one display connected to the controller.

15. The process of claim 14, wherein the at least one display includes at least one of an integrated screen and a mobile device.

16. The process of claim 15, further comprising receiving an update to at least one of the received parameters via an input associated with the at least one of the integrated screen and the mobile device, and determining a magnitude of the update.

17. The process of claim 16, further comprising responding to the magnitude exceeding a predefined magnitude threshold by re-optimizing the charging profile based on the plurality of received parameters using the multi-objective constrained optimization problem, wherein the plurality of received parameters includes the update to the at least one of the received parameters.

18. The process of claim 17, wherein the predefined magnitude threshold is a static magnitude.

19. The process of claim 17, wherein the predefined magnitude threshold is a percentage change in magnitude.

20. The process of claim 12, wherein the plurality of received parameters includes a selected charging type.
